(19) United States
(12) Patent Application Publication
(10) Pub. No.: US 2026/0222297 A1
(43) Pub. Date: Jul. 30, 2026

(54) Collectives-Aware Network Configuration

(71) Applicant: Mellanox Technologies, Ltd., Yokneam (IL)

(72) Inventors: Omer Shabtai, Tel Aviv (IL); Matty Kadosh, Hadera (IL); Adi Horowitz, Lehavot Habashan (IL); Alon Gal, Tel Aviv (IL); Einav Zelig, Tel Aviv (IL); Ofek Barkai, Petah Tikva (IL); Sreeram Potluri, Milpitas, CA (US); Jacky Romano, Pardes Hana (IL)

(21) Appl. No.: 19/040,890

(22) Filed: Jan. 30, 2025

(51) Int. Cl. H04L 41/0893; H04L 41/16; H04L 45/302

(52) U.S. Cl. CPC H04L 41/0893; H04L 41/16; H04L 45/3065

(57) ABSTRACT

A system includes multiple processors to communicate with one another via one or more network devices. One or more of the processors are to specify, for a given type of a collective operation to be executed by the system, a packet-processing configuration to be applied by the network devices in processing packets relating to collective operations of the given type, and, during execution of a collective operation of the given type, to mark the packets relating to the collective operation with a mark indicative of the packet-processing configuration, thereby instructing one or more of the network devices to process the packets relating to the collective operation, responsively to the mark, in accordance with the packet-processing configuration.

### TECHNICAL FIELD

The present disclosure relates generally to collective operations in computing systems, and particularly to methods and systems for collective-operation-aware packet processing.

### BACKGROUND

Collective operations ("collectives") are operations in which multiple processors operate together to exchange, aggregate, or transform data. Non-limiting examples of collectives include "all-gather", in which each processor collects data from all other processors, and "all-reduce", in which processors combine data using operations such as summation or averaging. Collective operations ensure efficient communication and consistency across distributed systems, enabling large-scale computations and collaborative processing. Collectives are prevalent, for example, in training of Artificial Intelligence (AI) models.

### SUMMARY

An embodiment that is described herein provides a system including multiple processors to communicate with one another via one or more network devices. One or more of the processors are to specify, for a given type of a collective operation to be executed by the system, a packet-processing configuration to be applied by the network devices in processing packets relating to collective operations of the given type, and, during execution of a collective operation of the given type, to mark the packets relating to the collective operation with a mark indicative of the packet-processing configuration, thereby instructing one or more of the network devices to process the packets relating to the collective operation, responsively to the mark, in accordance with the packet-processing configuration.

In an embodiment, the one or more of the processors are to specify the packet-processing configuration by assigning a given Quality-of-Service (QoS) level to the packets. In another embodiment, the one or more of the processors are to specify the packet-processing configuration by selecting a lossy communication protocol for communicating the packets. In yet another embodiment, the one or more of the processors are to specify the packet-processing configuration by selecting a lossless communication protocol for communicating the packets.

In an example embodiment, the one or more of the processors are to specify the packet-processing configuration by specifying that the network devices are to route the packets using Adaptive Routing (AR). In an alternative embodiment, the one or more of the processors are to specify the packet-processing configuration by specifying that the network devices are to route the packets using static routing.

In some embodiments, the one or more of the processors are to mark the packets by setting a Differentiated Services Code Point (DSCP) field of the packets to a value indicative of the packet-processing configuration. In some embodiments, the collective operation is part of an Artificial Intelligence (AI) model training process.

There is additionally provided, in accordance with an embodiment that is described herein, a network device including multiple ports and a switch fabric. The switch fabric is to receive, via one of the ports, a packet that (i) relates to a collective operation of a given type, and (ii) is marked with a mark indicative of a packet-processing configuration specified for executing collective operations of the given type, and to process the packet in accordance with the packet-processing configuration indicated by the mark.

There is further provided, in accordance with an embodiment that is described herein, a method in a system that includes multiple processors that communicate with one another via network devices. The method includes specifying, for a given type of a collective operation to be executed by the system, a packet-processing configuration to be applied by the network devices in processing packets relating to collective operations of the given type. During execution of a collective operation of the given type, the packets relating to the collective operation are marked with a mark indicative of the packet-processing configuration, thereby instructing one or more of the network devices to process the packets relating to the collective operation, responsively to the mark, in accordance with the packet-processing configuration.

There is also provided, in accordance with an embodiment that is described herein, a method including receiving, in a network device, a packet that (i) relates to a collective operation of a given type, and (ii) is marked with a mark indicative of a packet-processing configuration specified for executing collective operations of the given type. The packet is processed by the network device in accordance with the packet-processing configuration indicated by the mark.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a computing system that performs collective operations, in accordance with an embodiment that is described herein;

FIG. 2 is a flow chart that schematically illustrates a method for packet generation in the system of FIG. 1, in accordance with an embodiment that is described herein;

FIG. 3 is a flow chart that schematically illustrates a method for packet processing in the system of FIG. 1, in accordance with an embodiment that is described herein; and

FIG. 4 is a block diagram that schematically illustrates a computing system that performs collective operations, in accordance with another embodiment that is described herein.

### DETAILED DESCRIPTION OF EMBODIMENTS

### OVERVIEW

A typical system that performs collective operations comprises multiple processors that are connected to one another by network devices. Processors may comprise, for example, Graphics Processing Units (GPUs) and/or Central Processing Units (CPUs). Network devices may comprise, for example, packet switches and/or routers.

Execution of collective operations involves extensive communication of packets among the processors, and therefore extensive processing of packets in the network devices. In practice, different types of collective operations differ from one another in their packet-processing characteristics and requirements. As such, no single packet-processing configuration can be optimal for all types of collectives.

Embodiments that are described herein provide methods and systems for improved execution of collective operations in a computing system. In some embodiments, at least some of the processors in the system run an application that, among other tasks, performs collective operations. A typical example is an application that trains an Artificial Intelligence (AI) model in a distributed manner using multiple GPUs. Distributed training typically involves sending training data to the GPUs, performing collective computations on the data, and collecting training results from the GPUs.

In some embodiments, the application specifies, for at least one type of collective operation, a "packet-processing configuration" that should be applied by the network devices in processing packets relating to collective operations of that type. The application may distinguish between multiple different types of collective operations, and specify a respective packet-processing configuration for each type.

In the present context, the term "packet-processing configuration" refers to any suitable configuration, setting, definition, choice of parameters and/or algorithm that affects the way packets are processed by the network devices. Examples of packet-processing configurations, which can be specified for the packets of a given type of collective operation, include the following: Assigning a specified Quality-of-Service (QoS) level (also referred to as service class) to the packets. Specifying that the packets should be communicated using a lossy communication protocol. Specifying that the packets should be communicated using a lossless communication protocol. Specifying that the packets should be routed using Adaptive Routing (AR). Specifying that the packets should be routed using static routing.

Typically, the packet-processing configurations are chosen to best match the specific requirements or characteristics of the corresponding types of collective operations. For example, a collective that involves a relatively small number of processors may be assigned a high QoS level in order to complete more quickly. As another example, a collective that involves communication between Data Centers (sometimes referred to as a "DC-to-DC" collective) may be assigned a lossy communication protocol. A collective that is confined to intra-DC communication may be assigned a lossless communication protocol.

In some embodiments, the processors instruct the network devices to apply the packet-processing configurations by marking the packets belonging to collective operations. Upon generating a packet relating to a collective of a given type, the processor generating the packet marks the packet with a mark that is indicative of the packet-processing configuration defined for that type of collective.

Upon receiving a marked packet, a network device processes the packet in accordance with the packet-processing configuration indicated by the mark. The processors may mark the packets in various ways, one example being setting a Differentiated Services Code Point (DSCP) field of the packets to a value indicative of the packet-processing configuration.

The disclosed techniques are highly effective in optimizing the operation of network devices to best match the actual collective operations being performed. As a result, overall application performance can be significantly improved.

### SYSTEM DESCRIPTION

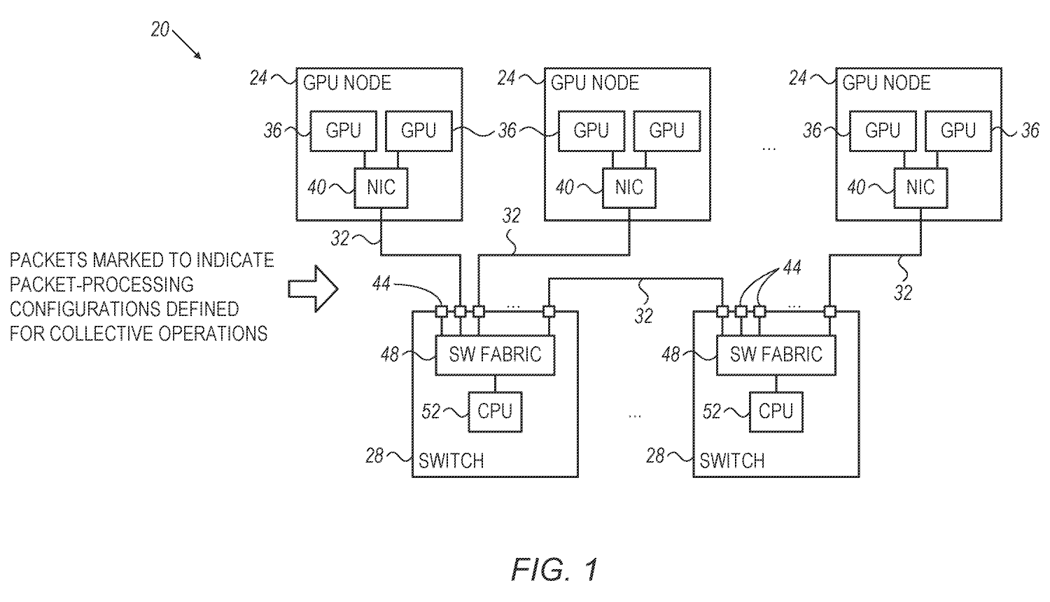

FIG. 1 is a block diagram that schematically illustrates a computing system 20 that performs collective operations, in accordance with an embodiment that is described herein. System 20 may comprise, for example, a Data Center (DC), a High-Performance Computing (HPC) cluster, or any other suitable type of computing system. In one example use-case system 20 is used for training AI models, although the disclosed techniques are in no way limited to any specific application.

System 20 comprises multiple GPU nodes 24 that are connected to one another by one or more packet switches 28. GPU nodes 24 and switches 28 communicate over network links 32. Each GPU node 24 in the present example comprises one or more GPUs 36 and one or more Network Interface Controllers (NICs) 40. Each switch 28 comprises multiple ports 44, a switch fabric 48 and a CPU 52. System 20 may operate in accordance with any suitable network protocol, e.g., Ethernet or InfiniBand™ (IB).

GPUs 36 typically run at least one application, e.g., an AI training application. As part of its operation, the application instructs at least some of the GPUs to jointly perform collective operations such as "all gather" or "all reduce". The terms "collective operations" and "collectives" are used interchangeably herein.

In performing a collective, GPUs 36 perform various computations, and also generate packets and communicate the packets with one another via switches 28. In some embodiments, upon generating a packet relating to a collective of a given type, the generating GPU 36 marks the packet with a mark that is indicative of the packet-processing configuration specified for the given type of collective. The GPU 36 sends the marked packet using NIC 40 to one of switches 28.

In some implementations, the marked packets are generated by GPUs 36 themselves. In other embodiments, the packets are generated by NICs 40 as part of serving GPUs 36. As such, in some embodiments the marks (indicative of the required packet-processing configurations) are inserted into the packets by GPU 36, while in other embodiments the marks are inserted by NICs 40 under instructions from GPUs 36.

All the above implementations, as well as any other suitable interplay between GPUs 36 and the NICs 40, are regarded herein as "a processor that generates and marks a packet". In this context, GPU node 24 as a whole is also considered a processor that generates and marks packets. More generally, packets may be generated and marked by any other suitable processor. For example, CPUs 52 of switches 28 may also participate as processors in the execution of collectives, and may themselves generate and mark packets.

Switches 28 receive the marked packets from GPU nodes 24 via ports 44, process the packets in accordance with the specified packet-processing configurations, and forward the packets via ports 44 to other switches 28 or to GPU nodes 24.

Typically, CPUs 52 of switches 28 are pre-configured with the packet-processing configurations defined for the various types of collectives. In an example embodiment, CPU 52 of each switch 28 is configured with a mapping that maps mark values to respective packet processing configurations. CPU 52 pre-configures fabric 48 of switch 28 to extract the mark from each marked packet, and to process the packet according to the packet-processing configuration indicated by the mark.

The configurations of system 20 and its components, e.g., GPU nodes 24 and switches 28, as depicted in FIG. 1, are example configurations that are chosen purely for the sake of conceptual clarity. Any other suitable configurations can be used in alternative embodiments.

For example, GPUs 36 need not necessarily be grouped in GPU nodes. As another example, NICs 40 may comprise any suitable type of network interfaces, e.g., IB Host Channel Adapters (HCAs), Data Processing Units (DPUs) and the like. The processors participating in the collectives may comprise, for example, CPUs, either in addition to or instead of GPUs.

In various embodiments, system 20 and its components, e.g., GPU nodes 24 and switches 28, may be implemented using suitable software, using suitable hardware such as one or more Application-Specific Integrated Circuits (ASIC) or Field-Programmable Gate Arrays (FPGA), or using a combination of hardware and software.

In some embodiments, certain elements of GPU nodes 24 and switches 28, e.g., GPUs 36, CPUs 52 and/or parts of NICs 40, are implemented using one more general-purpose processors, which are programmed in software to carry out the techniques described herein. The software may be downloaded to the processors in electronic form, over a network, for example, or it may, alternatively or additionally, be provided and/or stored on non-transitory tangible media, such as magnetic, optical, or electronic memory.

### COLLECTIVES-AWARE PACKET-PROCESSING CONFIGURATIONS

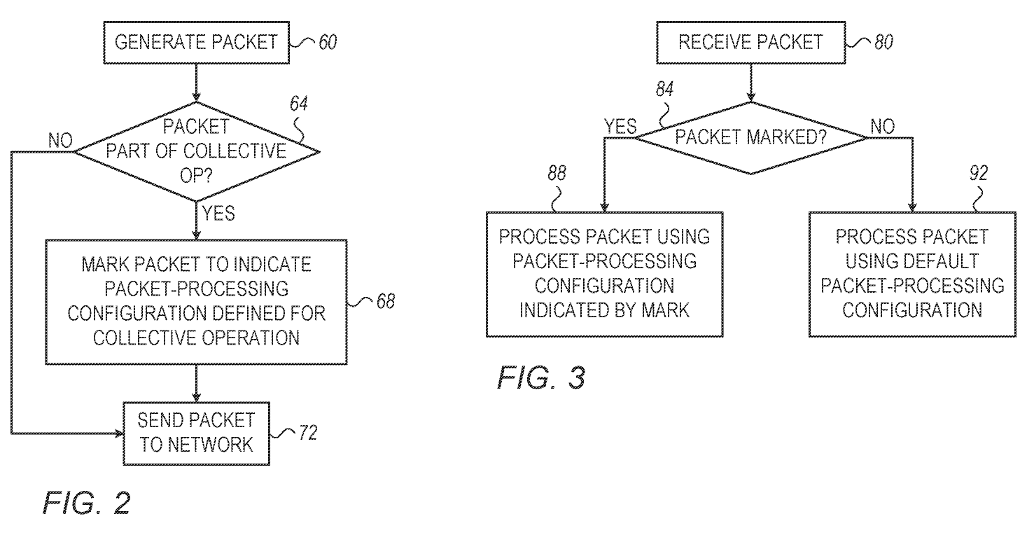

FIG. 2 is a flow chart that schematically illustrates a method for packet generation and marking, in accordance with an embodiment that is described herein. The method of FIG. 2 is typically performed by the processors of system 20, e.g., GPUs 36 or GPU nodes 24.

The method begins with a processor generating a packet for sending to another processor in system 20, at a packet generation operation 60. At a collectives checking operation 64, the processor checks whether the packet is related to a collective. If so, the processor marks the packet with a mark that is indicative of the packet-processing configuration defined for the type of collective, at a marking operation 68. In one non-limiting example, the processor sets the Differentiated Services Code Point (DSCP) field of the packet to a value indicative of the packet-processing configuration. Alternatively, any other suitable marking scheme can be used.

In various embodiments, the processor may specify any suitable packet-processing configuration for the packets of any suitable type of collective. A few non-limiting examples include (i) assigning a specified QoS level to the packets, (ii) specifying that the packets are to be communicated using a lossy communication protocol, (iii) specifying that the packets are to be communicated using a lossless communication protocol, (iv) specifying that the packets are to be routed using Adaptive Routing (AR), and/or specifying that the packets are to be routed using static routing.

If the packet is not related to a collective, operation 68 is skipped and the packet is not marked. At a sending operation 72, the processor sends the packet to one of switches 28.

FIG. 3 is a flow chart that schematically illustrates a method for packet processing, in accordance with an embodiment that is described herein. The method of FIG. 3 is typically performed by switches 28 of system 20.

The method begins with a switch 28 receiving a packet via one of ports 44, at a packet reception operation 80. The packet originates from one of the processors, and may arrive at the switch either from the processor or via another switch.

At a marking checking operation 84, switch fabric 48 checks whether the packet contains a mark that indicates a required packet-processing configuration. If the packet is marked, fabric 48 processes the packet using the packet-processing configuration indicated by the mark, at a marked-packet processing operation 88. If the packet is not marked, fabric 48 processes the packet using some default packet-processing configuration, at an unmarked-packet processing operation 92.

### EXAMPLE SYSTEM USE-CASE

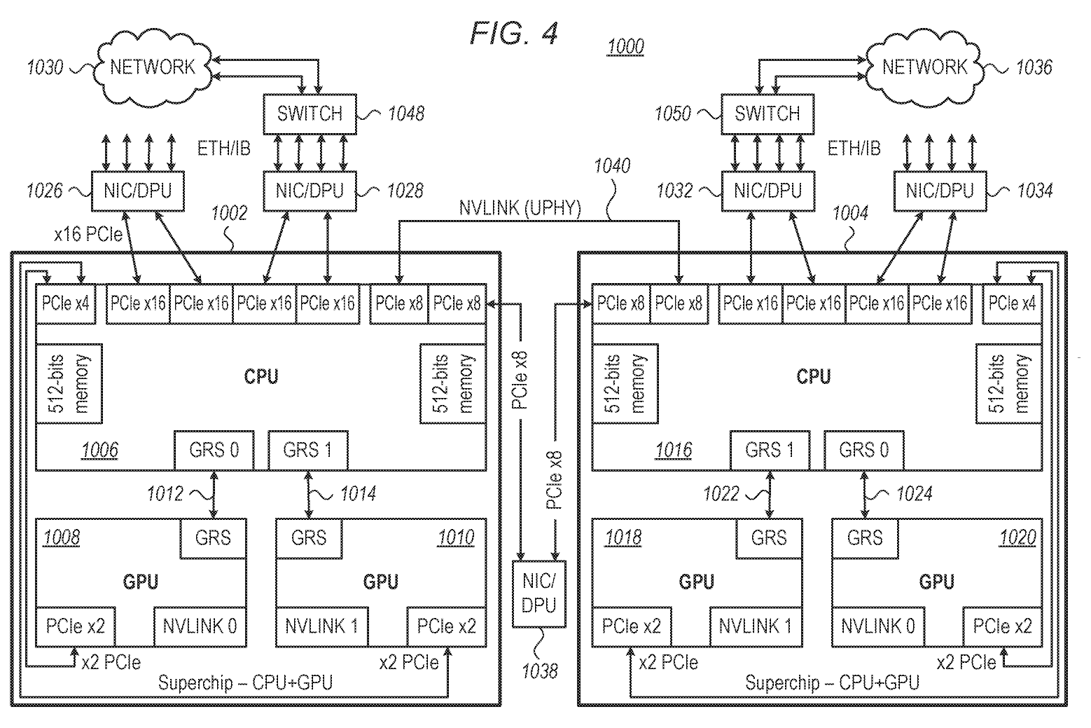

FIG. 4 is a block diagram that schematically illustrates a computing system 1000, e.g., a data center or a High-Performance Computing (HPC) cluster, which perform collective operations, in accordance with an embodiment described herein. System 1000 comprises a plurality of subsystems, e.g. multiple processing devices coupled to each other, multiple network devices, and multiple networks, according to at least one embodiment. Computing system 1000 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 1000 and to one or more external networks 1030, 1036. In the present example, system 1000 comprises a packet switch 1048 that connects NIC/DPU 1028 to network 1030, and a packet switch 1050 that connects NIC/DPU 1032 to network 1036.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs.

FIG. 4 also demonstrates an example architecture of a multi-GPU architecture. As illustrated in the figure, computing system 1000 includes a processing device 1002 with a multi-GPU architecture. In particular, processing device 1002 may be a system-on-chip and includes multiple subsystems such as a CPU 1006, a GPU 1008, and a GPU 1010. CPU 1006 can be coupled to GPU 1008 via a die-to-die (D2D) or chip-to-chip (C2C) interconnect 1012, such as a Ground-Referenced Signaling interconnect (GRS interconnect). CPU 1006 can be coupled to GPU 1010 via a D2D or C2C interconnect 1014. CPU 1006 can also couple to GPU 1008 and GPU 1010 via PCIe interconnects.

CPU 1006 can be coupled to one or more NICs or DPUs, which are coupled to one or more networks. For example, as illustrated in FIG. 4, CPU 1006 is coupled to a first NIC/DPU 1026, which is coupled to a network 1030. CPU 1006 is also coupled to a second NIC/DPU 1028, which is coupled to network 1030 via switch 1048. NIC/DPU 1026 and NIC/DPU 1028 can be coupled to network 1030 over Ethernet (ETH), NVLINK or InfiniBand (IB) connections, for example.

Computing system 1000 also includes a processing device 1004 with a multi-GPU architecture. In particular, processing device 1004 includes multiple subsystems including a CPU 1016, a GPU 1018, and a GPU 1020. CPU 1016 can be coupled to GPU 1018 via an D2D or C2C interconnect 1022. CPU 1016 can be coupled to GPU 1020 via a D2D or C2C interconnect 1024. CPU 1016 can also couple to GPU 1018 and GPU 1020 via PCIe interconnects. CPU 1016 can be coupled to one or more NICs or DPUs, which are coupled to one or more networks. For example, as illustrated in FIG. 4, CPU 1016 is coupled to a first NIC/DPU 1032, which is coupled to a network 1036. CPU 1016 is also coupled to a second NIC/DPU 1034, which is coupled to network 1036 via switch 1050. NIC/DPU 1032 and NIC/DPU 1034 can be coupled to network 1036 over Ethernet (ETH), NVLINK or InfiniBand (IB) connections.

In at least one embodiment, processing device 1002 and processing device 1004 can communication with each other via a NIC/DPU 1038, such as over PCIe interconnects. Processing device 1002 and processing device 1004 can also communicate with each other over a high-bandwidth communication interconnects 1040, such as an NVLink interconnect or other high-speed interconnects.

The packet switches in FIG. 4 may comprise, for example, Nvidia Quantum-2 switches. The NICs/DPUs in the figure may comprise, for example, Nvidia Bluefield DPUs. In various embodiments, system 1000 may execute collective operations, e.g., as part of AI training, using the disclosed techniques.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A system, comprising multiple processors to communicate with one another via one or more network devices, wherein one or more of the processors are to:
specify, for a given type of a collective operation to be executed by the system, a packet-processing configuration to be applied by the network devices in processing packets relating to collective operations of the given type; and
during execution of a collective operation of the given type, mark the packets relating to the collective operation with a mark indicative of the packet-processing configuration, thereby instructing one or more of the network devices to process the packets relating to the collective operation, responsively to the mark, in accordance with the packet-processing configuration.

2. The system according to claim 1, wherein the one or more of the processors are to specify the packet-processing configuration by assigning a given Quality-of-Service (QoS) level to the packets.

3. The system according to claim 1, wherein the one or more of the processors are to specify the packet-processing configuration by selecting a lossy communication protocol for communicating the packets.

4. The system according to claim 1, wherein the one or more of the processors are to specify the packet-processing configuration by selecting a lossless communication protocol for communicating the packets.

5. The system according to claim 1, wherein the one or more of the processors are to specify the packet-processing configuration by specifying that the network devices are to route the packets using Adaptive Routing (AR).

6. The system according to claim 1, wherein the one or more of the processors are to specify the packet-processing configuration by specifying that the network devices are to route the packets using static routing.

7. The system according to claim 1, wherein the one or more of the processors are to mark the packets by setting a Differentiated Services Code Point (DSCP) field of the packets to a value indicative of the packet-processing configuration.

8. The system according to claim 1, wherein the collective operation is part of an Artificial Intelligence (AI) model training process.

9. A network device, comprising:
multiple ports; and
a switch fabric, to:
receive, via one of the ports, a packet that (i) relates to a collective operation of a given type, and (ii) is marked with a mark indicative of a packet-processing configuration specified for executing collective operations of the given type; and
process the packet in accordance with the packet-processing configuration indicated by the mark.

10. A method, comprising:
in a system that includes multiple processors that communicate with one another via network devices, specifying, for a given type of a collective operation to be executed by the system, a packet-processing configuration to be applied by the network devices in processing packets relating to collective operations of the given type; and
during execution of a collective operation of the given type, marking the packets relating to the collective operation with a mark indicative of the packet-processing configuration, thereby instructing one or more of the network devices to process the packets relating to the collective operation, responsively to the mark, in accordance with the packet-processing configuration.

11. The method according to claim 10, wherein specifying the packet-processing configuration comprises assigning a given Quality-of-Service (QoS) level to the packets.

12. The method according to claim 10, wherein specifying the packet-processing configuration comprises selecting a lossy communication protocol for communicating the packets.

13. The method according to claim 10, wherein specifying the packet-processing configuration comprises selecting a lossless communication protocol for communicating the packets.

14. The method according to claim 10, wherein specifying the packet-processing configuration comprises instructing the network devices to route the packets using Adaptive Routing (AR).

15. The method according to claim 10, wherein specifying the packet-processing configuration comprises instructing the network devices to route the packets using static routing.

16. The method according to claim 10, wherein marking the packets comprises setting a Differentiated Services Code Point (DSCP) field of the packets to a value indicative of the packet-processing configuration.

17. The method according to claim 10, wherein the collective operation is part of an Artificial Intelligence (AI) model training process.

18. A method, comprising:
receiving, in a network device, a packet that (i) relates to a collective operation of a given type, and (ii) is marked with a mark indicative of a packet-processing configuration specified for executing collective operations of the given type; and
processing the packet by the network device in accordance with the packet-processing configuration indicated by the mark.
